(19) United States
(12) Patent Application Publication
(10) Pub. No.: US 2023/0303253 A1
(43) Pub. Date: Sep. 28, 2023

(54) VEHICLE CABIN TOTAL PRESSURE AND OXYGEN CONCENTRATION CONTROL

(71) Applicant: Hamilton Sundstrand Corporation, Charlotte, NC (US)

(72) Inventors: Diego S. Mugurusa, North Haven, CT (US); Ashley Himmelmann, Hartford, CT (US)

(21) Appl. No.: 17/713,767

(22) Filed: Apr. 5, 2022

Related U.S. Application Data
(60) Provisional application No. 63/323,266, filed on Mar. 24, 2022.

(51) Int. Cl. B64D 13/06; B64G 1/48; G05D 7/06

(52) U.S. Cl. CPC B64D 13/06; B64G 1/48; G05D 7/0635; B64D 2013/0681

(57) ABSTRACT

An environmental control system in a vehicle includes a pressurized tank of nitrox, which is a mixture of nitrogen and oxygen, and a delivery valve to block or allow a flow of the nitrox from the pressurized tank to a cabin of the vehicle. The environmental control system also includes a controller to control the delivery valve based on a total pressure or an oxygen partial pressure in the cabin.

### CROSS-REFERENCE TO RELATED APPLICATIONS

This application claims the benefit of U.S. Provisional Application No. 63/323,266 filed Mar. 24, 2022, the disclosure of which is incorporated herein by reference in its entirety.

### BACKGROUND

Exemplary embodiments pertain to the art of vehicle cabin environmental control and, in particular, to vehicle cabin total pressure and oxygen concentration control.

Environmental controls are important in many environments (e.g., homes, businesses, vehicles). In an aircraft or space vehicle, cabin pressure and oxygen concentration must be controlled along with temperature and humidity. Unlike a terrestrial habitat or vehicle, which is constantly replenished with oxygenated air, an aircraft or space vehicle must have oxygen added as it is depleted through breathing or leaks. The concentration of oxygen must also be controlled in view of the pressure that is maintained in the vehicle cabin.

### BRIEF DESCRIPTION

In one exemplary embodiment, an environmental control system in a vehicle includes a pressurized tank of nitrox, which is a mixture of nitrogen and oxygen, and a delivery valve to block or allow a flow of the nitrox from the pressurized tank to a cabin of the vehicle. The environmental control system also includes a controller to control the delivery valve based on a total pressure or an oxygen partial pressure in the cabin.

In addition to one or more of the features described herein, the environmental control system also includes a cabin pressure sensor to indicate the total pressure (Ptotal) in the cabin and a cabin oxygen sensor configured to indicate oxygen concentration (% O₂) in the cabin.

In addition to one or more of the features described herein, the controller determines the oxygen partial pressure ppO₂ as:

ppO₂=Ptotal*% O₂.

In addition to one or more of the features described herein, the environmental control system also includes a pressure regulator to reduce a pressure of the nitrox in the pressurized tank prior to delivery of the nitrox to the cabin of the vehicle via the delivery valve.

In addition to one or more of the features described herein, the environmental control system also includes a vent valve to vent the nitrox to an external atmosphere based on a failure of the pressure regulator.

In addition to one or more of the features described herein, the environmental control system also includes a relief valve to automatically open a flow from the cabin to an external atmosphere based on the total pressure in the cabin exceeding a threshold value.

In addition to one or more of the features described herein, the environmental control system also includes an external pressure sensor to indicate pressure in the external atmosphere and an isolation valve configured to shut off the flow from the cabin to the external atmosphere based on a fault in the relief valve indicated by the total pressure in the cabin being less than the pressure in the external atmosphere.

In addition to one or more of the features described herein, the controller controls the delivery valve to allow the flow of the nitrox from the pressurized tank to the cabin based on either the total pressure in the cabin being below a defined lower limit of the total pressure or the oxygen partial pressure in the cabin being below a defined lower limit of the oxygen partial pressure.

In addition to one or more of the features described herein, the controller controls the delivery valve to block the flow of the nitrox from the pressurized tank to the cabin based on either the total pressure in the cabin being above a defined upper limit of the total pressure or the oxygen partial pressure in the cabin being above a defined upper limit of the oxygen partial pressure.

In addition to one or more of the features described herein, the vehicle is an aircraft or a spacecraft.

In another exemplary embodiment, a method of assembling an environmental control system for a vehicle includes obtaining a pressurized tank of nitrox, which is a mixture of nitrogen and oxygen, and arranging a delivery valve to block or allow a flow of the nitrox from the pressurized tank to a cabin of the vehicle. The method also includes configuring a controller to control the delivery valve based on a total pressure or an oxygen partial pressure in the cabin.

In addition to one or more of the features described herein, the method also includes arranging a cabin pressure sensor to indicate the total pressure (Ptotal) in the cabin and a cabin oxygen sensor to indicate oxygen concentration (% O₂) in the cabin.

In addition to one or more of the features described herein, the configuring the controller includes the controller determining the oxygen partial pressure ppO₂ as:

ppO₂=Ptotal*% O₂.

In addition to one or more of the features described herein, the method also includes arranging a pressure regulator to reduce a pressure of the nitrox in the pressurized tank prior to delivery of the nitrox to the cabin of the vehicle via the delivery valve.

In addition to one or more of the features described herein, the method also includes arranging a vent valve to vent the nitrox to an external atmosphere based on a failure of the pressure regulator.

In addition to one or more of the features described herein, the method also includes arranging a relief valve to automatically open a flow from the cabin to an external atmosphere based on the total pressure in the cabin exceeding a threshold value.

In addition to one or more of the features described herein, the method also includes arranging an external pressure sensor to indicate pressure in the external atmosphere and an isolation valve to shut off the flow from the cabin to the external atmosphere based on a fault in the relief valve indicated by the total pressure in the cabin being less than the pressure in the external atmosphere.

In addition to one or more of the features described herein, the configuring the controller includes the controller controlling the delivery valve to allow the flow of the nitrox from the pressurized tank to the cabin based on either the total pressure in the cabin being below a defined lower limit of the total pressure or the oxygen partial pressure in the cabin being below a defined lower limit of the oxygen partial pressure.

In addition to one or more of the features described herein, the configuring the controller includes the controller controlling the delivery valve to block the flow of the nitrox from the pressurized tank to the cabin based on either the total pressure in the cabin being above a defined upper limit of the total pressure or the oxygen partial pressure in the cabin being above a defined upper limit of the oxygen partial pressure.

In addition to one or more of the features described herein, the vehicle is an aircraft or a spacecraft.

### BRIEF DESCRIPTION OF THE DRAWINGS

The following descriptions should not be considered limiting in any way. With reference to the accompanying drawings, like elements are numbered alike:

FIG. 1 is a block diagram of an environmental control system in a vehicle according to one or more embodiments; and

FIG. 2 is a process flow of a method of controlling the total pressure and oxygen concentration in the vehicle cabin according to one or more embodiments.

### DETAILED DESCRIPTION

A detailed description of one or more embodiments of the disclosed apparatus and method are presented herein by way of exemplification and not limitation with reference to the Figures.

Embodiments of the systems and methods detailed herein relate to vehicle cabin total pressure and oxygen concentration control. Generally, the total pressure in a vehicle cabin on the earth's surface is about 14.7 parts per square inch absolute (psia) and the oxygen concentration in air is about 21 percent. Ambient pressure decreases as altitude increases. Thus, during accent of the vehicle, as external pressure decreases, the total pressure in the vehicle cabin may be decreased (e.g., to 10 psia) to maintain a given differential pressure between the external and vehicle cabin pressures while also ensuring that the total pressure in the vehicle cabin exceeds external pressure. As the total pressure in the vehicle cabin is decreased, the oxygen concentration must be increased to maintain a habitable environment for occupants of the vehicle cabin. During descent, as the external pressure increases with decreasing altitude, the total pressure in the vehicle cabin must be increased. The oxygen concentration may be decreased correspondingly or maintained at the higher concentration.

Prior approaches to implementing environmental control in a vehicle cabin involved using a dual gas delivery system. High pressure oxygen and nitrogen were stored in separate tanks and their release was controlled to obtain a desired total pressure and oxygen concentration in the vehicle cabin. As detailed, the environmental control system according to one or more embodiments uses a single gas, a nitrogen/oxygen mixture (nitrox), rather than the dual gas system. The delivery of nitrox into the vehicle cabin is controlled to increase total pressure and/or to increase the concentration of oxygen.

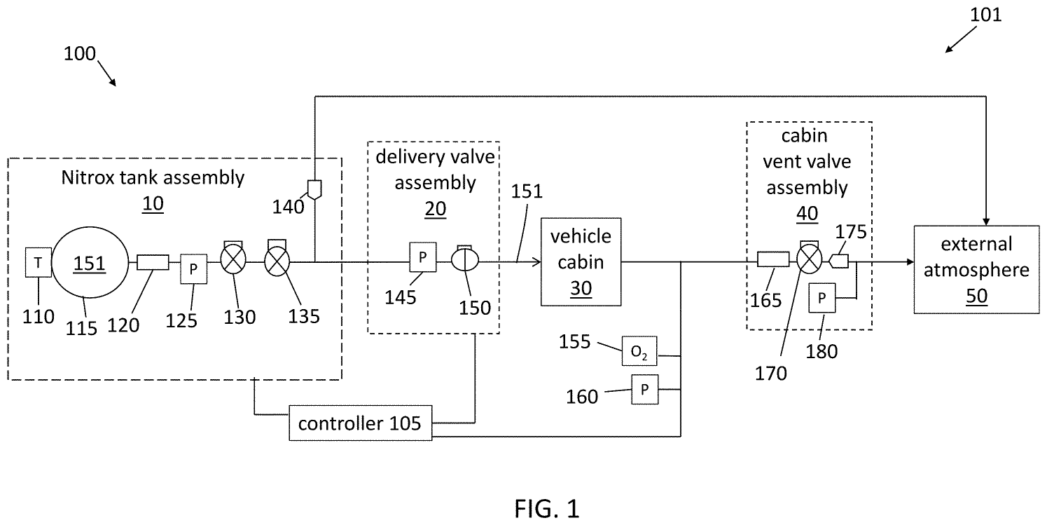

FIG. 1 is a block diagram of an environmental control system 100 in a vehicle 101 according to one or more embodiments. Generally, the environmental control system 100 includes a nitrox tank assembly 10 and a delivery valve assembly 20 to deliver nitrox 151 into the vehicle cabin 30, and a cabin vent valve assembly 40 to release pressure to the external atmosphere 50. Delivery of the nitrox 151 to the vehicle cabin 30 is controlled by a controller 105, as detailed.

The nitrox tank assembly 10 includes a nitrox temperature sensor 110 and nitrox pressure senor 125 that facilitate a calculation of the remaining nitrox 151 in the tank 115. The tank 115 may be a pressurized tank that maintains a pressure of about 3000 to 6000 psia, for example. A particulate filter 120 may be included at the outlet of the tank 115. An isolation valve 130 is used to shut off the flow of nitrox 151 in case of a failure, and a pressure regulator 135 facilitates reduction of the pressure of the nitrox 151 from the pressure in the tank 115 (e.g., 3000-6000 psia) to an intermediate pressure (e.g., 30-100 psi). In case of a failure in the pressure regulator 135, a vent valve 140 vents nitrox 151 (which is at a higher pressure than the intermediate pressure) to the external atmosphere 50 and thereby prevents over-pressurization of the vehicle cabin 30. The nitrox 151 may be 35 percent (%) oxygen O₂ and 65% nitrogen N₂, for example. This is further discussed.

The delivery valve assembly 20 includes a downstream pressure sensor 145 that monitors pressure of the nitrox 151 leaving the nitrox tank assembly 10 following the pressure decrease by the pressure regulator 135. Thus, the downstream pressure sensor 145 provides an indication of the health of the pressure regulator 135 and may be a basis for operation of the vent valve 140. The delivery valve assembly 20 also includes a delivery valve 150 that is controlled by the controller 105 to supply nitrox 151 to the vehicle cabin 30. The delivery valve 150 may be a two-way solenoid valve that is normally closed and may be controlled to open to deliver the nitrox 151 to the vehicle cabin 30.

A cabin oxygen sensor 155 and a cabin pressure sensor 160 facilitate monitoring of oxygen partial pressure and total pressure in the vehicle cabin 30 and are used by the controller 105 to control the delivery valve 150. The cabin oxygen sensor 155 indicates the concentration of oxygen (% O₂) in the vehicle cabin 30, and the cabin pressure sensor 160 indicates the total pressure (Ptotal) in the vehicle cabin 30. Oxygen partial pressure (ppO₂) may be determined from the concentration of oxygen (% O₂) and the total pressure (Ptotal) as:

ppO₂=Ptotal*% O₂ [EQ. 1]

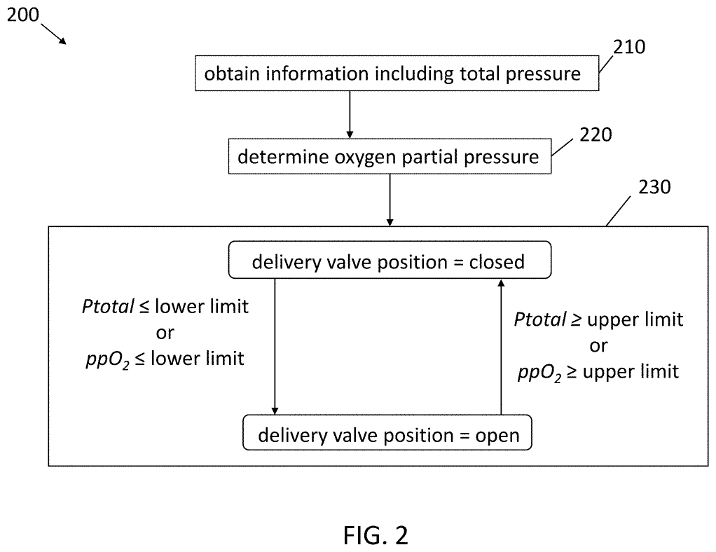

Operation of the controller 105 based on the oxygen partial pressure (ppO₂) and total pressure (Ptotal) is further discussed with reference to FIG. 2. Generally, the controller 105 causes nitrox 151 to be delivered into the vehicle cabin 30 when either the oxygen partial pressure (ppO₂) or total pressure (Ptotal) needs to be increased. In this regard, the percentage of oxygen in the nitrox 151 (e.g., 35%) may be greater than the maximum desired oxygen partial pressure (ppO₂) to prevent the total pressure (Ptotal) from increasing too much when oxygen partial pressure (ppO₂) needs to be increased. However, this criterion must be balanced with the fact that too high a percentage of oxygen in the nitrox 151 may result in over-enriching the vehicle cabin 30 with oxygen.

The cabin vent valve assembly 40 may include a filter 165. A relief valve 175 of the cabin vent valve assembly 40 automatically opens, as needed. That is, the relief valve 175 may be a mechanically operated valve that opens based on a particular pressure being exceeded. According to alternate embodiments, the relief valve 175 may also be controlled by the controller 105, like the delivery valve 150. The relief valve 175 maintains a pressure difference between the total pressure in the vehicle cabin 30 (measured by the cabin pressure sensor 160) and external pressure (measured by the external pressure sensor 180) within a predefined range by opening when the total pressure in the vehicle cabin 30 is too high. When the total pressure in the vehicle cabin 30 is too low, nitrox 151 is delivered via the delivery valve 150 based on control by the controller 105. An isolation valve 170 of the cabin vent valve assembly 40 shuts off flow from the vehicle cabin 30 to the external atmosphere 50 in case of a fault in the relief valve 175. This prevents the total pressure in the vehicle cabin 30 from falling below the pressure of the external atmosphere 50.

FIG. 2 is a process flow of a method 200 of controlling the delivery valve 150 to control the total pressure and oxygen concentration (reflected by oxygen partial pressure) in the vehicle cabin 30 according to one or more embodiments. The processes shown in FIG. 2 may be performed by the controller 105. The controller 105 may include one or more memory devices and processors to implement the control functionality. At block 210, the processes include obtaining information including total pressure in the vehicle cable 30. The processes include obtaining the concentration of oxygen (% O₂) in the vehicle cabin 30 from the cabin oxygen sensor 155 and obtaining the total pressure (Ptotal) in the vehicle cabin 30 from the cabin pressure sensor 160.

At block 220, determining oxygen partial pressure (ppO₂) refers to the implementing the computation shown in EQ. 1. At block 230, controlling the delivery valve 150 is based on the total pressure Ptotal and the oxygen partial pressure ppO₂ in the vehicle cabin 30, as shown. Specifically, the total pressure Ptotal and the oxygen partial pressure ppO₂ in the vehicle cabin 30 are each maintained within upper and lower limits. These limits may change based on altitude (e.g., the total pressure Ptotal upper limit may be lower at higher altitudes) or may be interrelated (e.g., the oxygen partial pressure ppO₂ (reflecting oxygen concentration) may decrease with decreased total pressure Ptotal).

As shown in FIG. 2, when either the total pressure Ptotal or the oxygen partial pressure ppO₂ in the vehicle cabin 30 is below its defined lower limit, the controller 105 may control the delivery valve 150 to open (or remain open) and thereby allow the flow of nitrox 151 into the vehicle cabin 30. When either the total pressure Ptotal or the oxygen partial pressure ppO₂ in the vehicle cabin 30 is above its defined upper limit, the controller 105 may control the delivery valve 150 to close (or remain closed) and thereby prevent the flow of nitrox 151 into the vehicle cabin 30. As previously noted, when the total pressure Ptotal in the vehicle cabin 30 exceeds the upper limit (or a different, higher threshold value), the relief valve 175 may vent air from the vehicle cabin 30 to the external atmosphere 50 to prevent over-pressurization of the vehicle cabin 30.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system in a vehicle, the environmental control system comprising:
a pressurized tank of nitrox, which is a mixture of nitrogen and oxygen;
a delivery valve configured to block or allow a flow of the nitrox from the pressurized tank to a cabin of the vehicle; and
a controller configured to control the delivery valve based on a total pressure or an oxygen partial pressure in the cabin.

2. The environmental control system according to claim 1, further comprising a cabin pressure sensor configured to indicate the total pressure (Ptotal) in the cabin and a cabin oxygen sensor configured to indicate oxygen concentration (% O₂) in the cabin.

3. The environmental control system according to claim 2, wherein the controller is configured to determine the oxygen partial pressure ppO₂ as:
ppO₂=Ptotal*% O₂.

4. The environmental control system according to claim 1, further comprising a pressure regulator configured to reduce a pressure of the nitrox in the pressurized tank prior to delivery of the nitrox to the cabin of the vehicle via the delivery valve.

5. The environmental control system according to claim 4, further comprising a vent valve configured to vent the nitrox to an external atmosphere based on a failure of the pressure regulator.

6. The environmental control system according to claim 1, further comprising a relief valve configured to automatically open a flow from the cabin to an external atmosphere based on the total pressure in the cabin exceeding a threshold value.

7. The environmental control system according to claim 6, further comprising an external pressure sensor configured to indicate pressure in the external atmosphere and an isolation valve configured to shut off the flow from the cabin to the external atmosphere based on a fault in the relief valve indicated by the total pressure in the cabin being less than the pressure in the external atmosphere.

8. The environmental control system according to claim 1, wherein the controller is configured to control the delivery valve to allow the flow of the nitrox from the pressurized tank to the cabin based on either the total pressure in the cabin being below a defined lower limit of the total pressure or the oxygen partial pressure in the cabin being below a defined lower limit of the oxygen partial pressure.

9. The environmental control system according to claim 1, wherein the controller is configured to control the delivery valve to block the flow of the nitrox from the pressurized tank to the cabin based on either the total pressure in the cabin being above a defined upper limit of the total pressure or the oxygen partial pressure in the cabin being above a defined upper limit of the oxygen partial pressure.

10. The environmental control system according to claim 1, wherein the vehicle is an aircraft or a spacecraft.

11. A method of assembling an environmental control system for a vehicle, the method comprising:
obtaining a pressurized tank of nitrox, which is a mixture of nitrogen and oxygen;
arranging a delivery valve to block or allow a flow of the nitrox from the pressurized tank to a cabin of the vehicle; and
configuring a controller to control the delivery valve based on a total pressure or an oxygen partial pressure in the cabin.

12. The method according to claim 11, further comprising arranging a cabin pressure sensor to indicate the total pressure (Ptotal) in the cabin and a cabin oxygen sensor to indicate oxygen concentration (% O₂) in the cabin.

13. The method according to claim 12, wherein the configuring the controller includes the controller determining the oxygen partial pressure ppO₂ as:
ppO₂=Ptotal*% O₂.

14. The method according to claim 11, further comprising arranging a pressure regulator to reduce a pressure of the nitrox in the pressurized tank prior to delivery of the nitrox to the cabin of the vehicle via the delivery valve.

15. The method according to claim 14, further comprising arranging a vent valve to vent the nitrox to an external atmosphere based on a failure of the pressure regulator.

16. The method according to claim 11, further comprising arranging a relief valve to automatically open a flow from the cabin to an external atmosphere based on the total pressure in the cabin exceeding a threshold value.

17. The method according to claim 16, further comprising arranging an external pressure sensor to indicate pressure in the external atmosphere and an isolation valve to shut off the flow from the cabin to the external atmosphere based on a fault in the relief valve indicated by the total pressure in the cabin being less than the pressure in the external atmosphere.

18. The method according to claim 11, wherein the configuring the controller includes the controller controlling the delivery valve to allow the flow of the nitrox from the pressurized tank to the cabin based on either the total pressure in the cabin being below a defined lower limit of the total pressure or the oxygen partial pressure in the cabin being below a defined lower limit of the oxygen partial pressure.

19. The method according to claim 11, wherein the configuring the controller includes the controller controlling the delivery valve to block the flow of the nitrox from the pressurized tank to the cabin based on either the total pressure in the cabin being above a defined upper limit of the total pressure or the oxygen partial pressure in the cabin being above a defined upper limit of the oxygen partial pressure.

20. The method according to claim 11, wherein the vehicle is an aircraft or a spacecraft.
